(19) United States
(12) Patent Application Publication
(10) Pub. No.: US 2011/0261879 A1
(43) Pub. Date: Oct. 27, 2011

(54) SCENE CUT DETECTION FOR VIDEO STREAM COMPRESSION

(75) Inventors: Alois Martin Bock, Hampshire (GB); Ryan Spicer, Hampshire (GB)

(73) Assignee: Telefonaktiebolaget LM Ericsson (publ), Stockholm (SE)

(21) Appl. No.: 12/671,882

(22) PCT Filed: Jul. 28, 2008
(86) PCT No.: PCT/EP08/59891

§ 371 Date: Jun. 21, 2011

(30) Foreign Application Priority Data
Aug. 2, 2007 (GB) 0715072.5

(51) Int. Cl. H04N 7/26

(52) U.S. Cl. 375/240.03; 375/E07.126

(57) ABSTRACT

A method and apparatus for detecting (51) in a video stream a scene cut (11, 12) between a current field of the video stream and an immediately preceding field includes determining (61) differences for a first plurality of image parameters between values of the image parameters for a current field and for one or more immediately preceding fields. A flag value is set (62) for each parameter indicating whether a possible scene break exists between the current field and the immediately preceding field dependent on the respective differences. The flag values for each parameter are combined (63) to form a combined parameter and a scene break trigger signal generated (64) indicating a scene break between the current field and the immediately preceding field if the combined parameter exceeds a predetermined trigger threshold. A change of criticality is determined (52) at a forthcoming scene cut. A quantisation parameter is adjusted (53) dependent on the criticality change to avoid overflowing a buffer on encoding of a field following the scene cut as an intra-coded field. A field following the scene cut is encoded (54) as an intra-coded field having a quantisation parameter dependent on the criticality change; such that encoding of forward or backward coded fields prior to or following the scene change is based only on fields preceding or following the scene change, respectively.

### TECHNICAL FIELD

This invention relates to scene cut detection in a video stream. The invention may be used in improved video compression of a video stream which includes a detected scene cut.

### BACKGROUND

Video signals usually comprise a series of scenes that follow each other in an organised stream, for example to convey a narrative of programme content. This is a fundamental feature of much television and motion picture film making Scene changes are chosen to support and enhance the programme maker's intentions and as such need to be retained by any moving image coding system such as MPEG compression. Significant changes can occur in image content between consecutive scenes, these are especially abrupt when a first frame of a new scene follows directly after a last of a coherent series of frames representing a previous scene. Sometimes a change is slower, for example when a scene change takes a form of a fade where two scenes are superimposed over a period of a few frames. The latter, slower change is easier to deal with in compression coders than the former, abrupt changes, which can cause severe picture quality degradation, particularly in early frames of the new scene following the scene cut. There is a requirement to avoid these degradations, for example by warning the compression coder of an impending scene change.

Typical known scene cut detection methods in current implementations use either changes in picture activities or luminosity to detect joining of different scenes, using hard threshold decisions to indicate a scene change. Although these simple schemes are effective in some cases, simulations have revealed that it is possible to have two consecutive scenes that are visually very different but have similar picture activities or luminosity. In this case, a legitimate scene cut would be missed and the consequences to coding performance could be detrimental. The lack of reliable and accurate indications from these systems indicates a requirement for more effective methods of detecting scene changes.

In the case of a video encoding system, what is required is prior knowledge of an impending scene cut to allow the system's rate-control process to adapt so that it might be in an appropriate state ready for the start of a new video sequence representing the new scene. If this does not occur, depending on the particular content of the current and the new sequence, poor video compression may result and displeasing visual content would be apparent to a viewer during the transition.

### SUMMARY

It is an object of the present invention at least to ameliorate the aforesaid disadvantages in the prior art.

According to a first aspect of the invention there is provided a method of detecting in a video stream a scene cut between a current field of the video stream and an immediately preceding field and encoding the video stream. The method comprises the steps of: determining differences for a first plurality of image parameters between values of the image parameters for a current field and for one or more immediately preceding fields; setting a flag value for each parameter indicating whether a possible scene break exists between the current field and the immediately preceding field dependent on the respective differences; combining the flag values for each parameter to form a combined parameter; and generating a scene break trigger signal indicating a scene break between the current field and the immediately preceding field if the combined parameter exceeds a predetermined trigger threshold. A change of criticality at the forthcoming scene cut is determined and a quantisation parameter adjusted dependent on the criticality change to avoid overflowing a buffer on encoding of a field following the scene cut as an intra-coded field. A field following the scene cut is encoded as an intra-coded field having a quantisation parameter dependent on the criticality change; such that encoding of forward or backward coded fields prior to or following the scene change is based only on fields preceding or following the scene change, respectively.

Conveniently, the image parameters include at least one of average luminosity, average chroma component, horizontal picture activity, vertical picture activity, temporal difference, histogram of a picture in a spatial domain and average motion vector magnitude.

Advantageously, determining a difference comprises: determining minimum and maximum values of at least one of luminosity and chroma values over a second plurality of immediately preceding fields; and determining whether the values of the respective at least one of luminosity and chroma values for the current field is greater than the maximum value or less than the minimum value by a respective luminosity or chroma parameter threshold.

Advantageously determining a difference comprises: determining a range between maximum and minimum values of at least one of vertical and horizontal activity over a second plurality of fields immediately preceding the current field; selecting a range multiplier parameter dependent on the range; determining a minimum parameter equal to a difference between the activity of the current field and the minimum activity in the second plurality of fields; determining a maximum parameter equal to a difference between the activity of the current field and the maximum activity in the second plurality of fields; and determining whether the activity is less than the minimum activity in the second plurality of fields and the minimum parameter is less than the range multiplier or if the activity is greater than the maximum activity in the second plurality of fields and the maximum parameter is greater than the range multiplier.

Advantageously, determining a difference comprises: determining a temporal difference between the current field and an immediately preceding field of a same parity; and determining whether the temporal difference exceeds a previous temporal difference for an immediately preceding pair of fields by more than a predetermined factor parameter.

Advantageously, determining a difference comprises: determining a normalised match index between the current field and an immediately preceding field; and determining whether the normalised match index is less than a predetermined histogram threshold.

Conveniently, the step of setting a flag value comprises determining whether the difference exceeds a predetermined parameter threshold.

Conveniently, the predetermined parameter threshold is variable in response to statistical knowledge of the image sequence of the video stream.

Conveniently, combining the flag values comprises summing the flag values.

Advantageously, combining the flag values comprises determining a weighted sum of the flag values.

Advantageously, the trigger threshold is variable in response to statistical knowledge of the image sequence of the video stream.

Advantageously, determining a change of criticality at a scene cut comprises the steps of: determining a range of criticality over a plurality of fields immediately preceding the scene cut; signalling an Easy-to-Hard scene cut if the criticality of the current field immediately following the scene cut exceeds a maximum criticality of the preceding plurality of fields; signalling a Hard-to-Easy scene cut if the criticality of the current field immediately following the scene cut is less than a minimum criticality of the preceding plurality of fields; and otherwise signalling a seamless scene cut.

According to a second aspect of the invention, there is provided an apparatus arranged to detect in a video stream a scene cut between a current field of the video stream and an immediately preceding field, the apparatus comprising: a comparison module arranged to determine differences for a first plurality of image parameters between values of the image parameters for a current field and for one or more immediately preceding fields; a flag setting module arranged to set a flag value for each parameter indicating whether a possible scene break exists between the current field and the immediately preceding field dependent on the respective differences; a flag combining module arranged to combine the flag values for each parameter to form a combined parameter; and a trigger generating module arranged to generate a scene break trigger signal indicating a scene break between the current field and the immediately preceding field if the combined parameter exceeds a predetermined trigger threshold. The apparatus also includes a criticality change module arranged to determine a change of criticality at the forthcoming scene cut; a quantisation parameter adjustment module arranged to adjust a quantisation parameter dependent on the criticality change to avoid overflowing a buffer on encoding of a field following the scene cut as an intra-coded field; an encoder arranged to encode a field following the scene cut as an intra-coded field having a quantisation parameter dependent on the criticality change; such that encoding of forward or backward coded fields prior to or following the scene change is based only on fields preceding or following the scene change, respectively.

Conveniently, the image parameters include at least one of average luminosity, average chroma component, horizontal picture activity, vertical picture activity, temporal difference, histogram of a picture in a spatial domain and average motion vector magnitude.

Advantageously, the comparison module comprises: a first module for determining minimum and maximum values of at least one of luminosity and chroma values over a second plurality of immediately preceding fields; and a second module for determining whether the values of the respective at least one of luminosity and chroma values for the current field is greater than the maximum value or less than the minimum value by a respective luminosity or chroma parameter threshold.

Advantageously, the comparison module is arranged to: determine a range between maximum and minimum values of at least one of vertical and horizontal activity over a second plurality of fields immediately preceding the current field; select a range multiplier parameter dependent on the range; determine a minimum parameter equal to a difference between the activity of the current field and the minimum activity in the second plurality of fields; determine a maximum parameter equal to a difference between the activity of the current field and the maximum activity in the second plurality of fields; and determine whether the activity is less than the minimum activity in the second plurality of fields and the minimum parameter is less than the range multiplier or if the activity is greater than the maximum activity in the second plurality of fields and the maximum parameter is greater than the range multiplier.

Advantageously, the comparison module is arranged: to determine a temporal difference between the current field and an immediately preceding field of a same parity; and to determine whether the temporal difference exceeds a previous temporal difference for an immediately preceding pair of fields by more than a predetermined factor parameter.

Advantageously, the comparison module is arranged to: determine a normalised match index between the current field and an immediately preceding field; and determine whether the normalised match index is less than a predetermined histogram threshold.

Conveniently, the flag setting module is arranged to determine whether the difference exceeds a predetermined parameter threshold.

Conveniently, the predetermined parameter threshold is variable in response to statistical knowledge of the image sequence of the video stream.

Advantageously, the flag combining module comprises summing means.

Preferably, the flag combining module is arranged to determine a weighted sum of the flag values.

Advantageously, the trigger threshold is variable in response to statistical knowledge of the image sequence of the video stream.

Advantageously, the criticality change module comprises: a module arranged to determine a range of criticality over a plurality of fields immediately preceding the scene cut; and signalling means arranged to signal to an Easy-to-Hard scene cut if the criticality of the current field immediately following the scene cut exceeds a maximum criticality of the preceding plurality of fields, to signal a Hard-to-Easy scene cut if the criticality of the current field immediately following the scene cut is less than a minimum criticality of the preceding plurality of fields; and otherwise to signal a seamless scene cut.

### BRIEF DESCRIPTION OF THE DRAWINGS

The invention will now be described, by way of example, with reference to the accompanying drawings in which:

FIG. 1 is an illustration of a group of pictures, including a scene cut, to which the invention may be applied;

FIG. 2 is a graph of buffer fullness with time showing potential buffer overflow due to insertion of an I-coded picture at a scene cut;

FIG. 3 is a graph of buffer fullness with time showing avoidance of a buffer overflow on a scene cut using an embodiment of the invention;

FIG. 4 is a histogram for determining a normalized match index, used in an embodiment of the invention;

FIG. 5 is a flowchart of a method according to the invention of accommodating a scene cut in a video compression system or process;

FIG. 6 is a flowchart of a method, according to the invention, of detecting a scene cut; and

FIG. 7 is a flowchart of a method, according to an embodiment of the invention, of detecting and signalling a change of criticality at a detected scene cut.

In the Figures, like reference numbers denote like parts.

### DETAILED DESCRIPTION

### Typical Image Coding Data Structure

Although a scene cut (SC) detection method and apparatus is described herein in the context of an MPEG2 encoder, the invention is applicable in any image compression process and any image manipulation system that requires knowledge of positions of scene changes.

To appreciate the invention, it is useful to understand a structure of a typical Group of Pictures (GOP) and the subsequent impact that a SC could have on encoding the GOP.

An MPEG2 GOP typically comprises:
Intra (I) pictures: coded independently of any other picture;
Forward (P) pictures: coded with reference to previous I or P pictures; and
Backward (B) pictures: coded with reference to previous or future I or P pictures.

When a SC occurs, an ideal situation would be for an I-picture to be inserted at the start of the new scene following the scene cut, so that the coding of this new scene would not depend on any I or P pictures from the preceding scene, before the scene cut. In order to ensure that this occurs, the structure of the corresponding GOP may have to be manipulated.

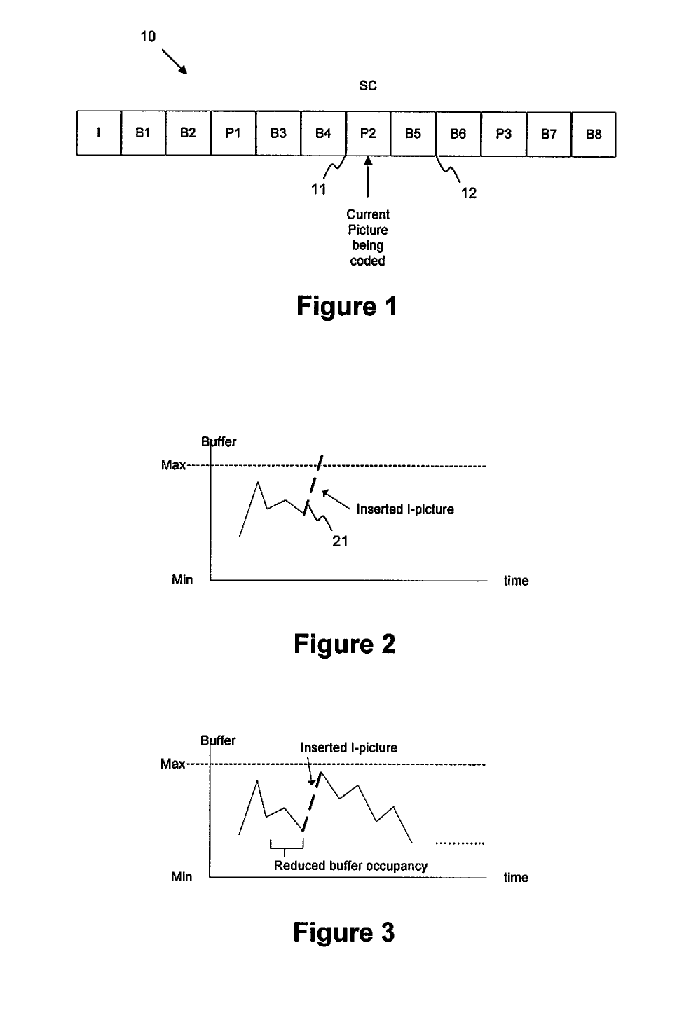

Consider FIG. 1, where a SC 11 occurs before what would be a P-picture (P2) in a GOP 10. In this case P2 is the first frame of a new scene and would be best compressed as an I picture, even though such pictures take more bits when compressed than a P picture. Thus, if the GOP remains unchanged, by definition, the current P-picture would have to reference the previous P-picture (P1) which is three frames distant in the past and, considering that the scenes could be completely different, an unexpectedly large number of bits would be required adequately to code the difference in scenes. If extra bits are not available for this purpose, as is most often the case, the P-picture would be an inferior version of the new scene and the effects thereof would ripple through the next few frames of the sequence until the encoder could correct itself. From a viewer's perspective, this would be clearly noticeable and aesthetically displeasing.

A solution to this problem would be to interrupt the GOP structure and to replace the P-picture P2 with an I-picture and in doing so, provide an accurate version of the new scene from which to take reference pictures in the next GOP.

Considering FIG. 1 again, if a SC 12 occurred between picture B5 and B6, an I-picture could be inserted instead of P3. In this case, B5, being a bi-directionally referenced picture that may take reference from a picture ahead of it or behind it in time, or both, would be able to reference the old scene represented by picture P2 and the picture B6 would be able to reference the new scene that would be an I-picture at position P3.

### Reliance of Rate-Control on Scene Cut Detection

Rate-control is a process to ensure that a resultant number of bits generated by an encoder does not overflow or underflow a rate buffer, which, in MPEG2 is known as a video buffer verifier (VBV) buffer. Fullness of the buffer is controlled by controlling a Quantisation Parameter (QP) which affects a degree to which coefficients of a DCT transform are quantised or deleted. An I picture is not coded differentially as P and B pictures are, that is it does not code the differences between images, which are in general small in value, and so does not lead to as low a number of bits per picture as coding P and B pictures do. It follows then that, other things being equal, the use of I pictures instead of P or B pictures to begin new scenes leads to an increase in a number of bits inserted into the buffer. If the buffer is already nearly full, then a value of the QP will be adjusted to reflect this fact and will constrain the coding of the I picture to avoid overflow. Thus this sudden influx of additional bits could be detrimental to picture quality. It follows therefore that simply forcing an I picture into a current GOP is not a complete solution to dealing with scene cuts.

In MPEG2 (Main Profile, Main Level), a maximum magnitude of the rate buffer can be up to 1.835 Mbits. This size is not very large in comparison with a number of bits generated per picture and so a rate-control process needs to be efficient and reliable in order to ensure that an instantaneous number of bits in the buffer never goes beyond either the minimum or maximum limit.

Referring to FIG. 1, if P2 is replaced by an I-picture and the rate-control process has not made allowance for the picture substitution, the buffer may exceed its maximum limit (overflow). This is illustrated in a graph of buffer fullness vs. time in FIG. 2, with a bold dashed line 21 indicating a position of a substituted I-picture.

However, referring to FIGS. 3 and 5, if the rate-control process had reliable prior knowledge that a SC was imminent, it could then dynamically adjust 53 the QP ahead of the actual scene change in order to reduce the number of bits in the buffer and in this way prepare space in the buffer for the impending I-picture at the beginning of the SC. By doing so, buffer overflows can be avoided.

Referring to FIG. 5, a more intelligent SC detection process that was able to give prior warning that a SC was imminent requires reliable knowledge of the behaviour of the picture sequence. With sufficient picture sequence analysis the process can also indicate 52 a type of scene transition, for example:
Seamless—the difficulty (criticality) in coding the new scene is similar to that of the old scene;
Hard-to-Easy: The criticality of the old scene is high whilst that of the new scene is low; and
Easy-to-Hard: The criticality of the new scene is high whilst that of the old scene is low.

A type of scene transition directly affects a preferred response of the rate-control process. For a hard-to-easy transition, if the QP of a picture with low criticality is too high, visual artefacts become apparent. In this case, it is desirable for the rate-control process to encode 54 the I-picture relating to the SC with a low QP thus reducing possible visual artefacts. For an easy-to-hard transition, the I-picture relating to the SC would naturally require more bits to code due to the complexity of the new scene, therefore the rate-control process would have to prepare the buffer and also select 53 a reasonable QP to ensure the buffer does not overflow. In the case of a seamless transition, there is little change in the criticalities between the new and old scenes hence the rate-control process only has to make enough space in the buffer for the I-picture and use 53 a similar QP to that used for the old scene. It is clear therefore that a dynamic and adaptive system is needed rather than one whose options are fixed.

### Scene Cut Detection

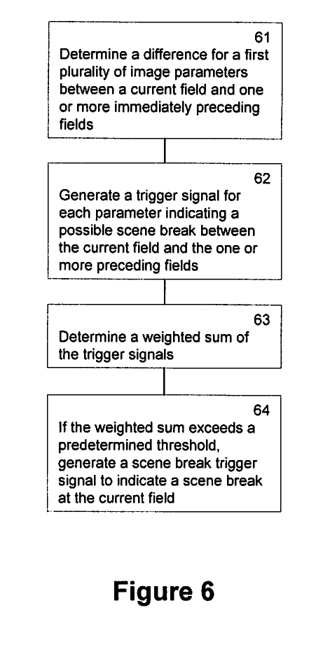

A key to successful management of the consequences of scene cuts is a reliable and accurate SC detection mechanism. Referring to FIG. 6, unlike known SC mechanisms that utilize simple models based either on changes in picture activities or in luminosity to detect scene changes, the process of the invention monitors progression of a number of image metrics over a number of input pictures to detect 61 differences in the metrics and so builds up a statistical model of an image sequence from which to predict 64 an impending SC with good accuracy. Typical metrics are:
Average luminosity (Y);
Average chroma component (U and V);
Picture activities (horizontal and vertical);
Temporal difference; and
Histogram of a picture in a spatial domain.

Although the invention is described here in terms of these metrics, it will be understood that other metrics such as average motion vector magnitude could be used together with, or in place of, one or more of the above mentioned metrics. This is because the process makes a final decision based on a plurality of metrics, irrespective of what they may be. A choice of metrics is limited by relevance of a given metric to image behaviour and also by differential costs of implementation. This will change with time as new technologies enable more complex image analysis processes to be used.

The metrics chosen will indicate, or trigger, a possible SC in different ways and thus will be described separately; in particular, but without limitation, the following descriptions show how each of the examples given above may be applied.

Average Y, U and V metrics

This metric is used to detect 61 an abrupt change in average luminosity or chroma which, taken with other metrics, may signify a scene cut. A trigger or flag is set 62 if the luminance or chroma differ from preceding pictures by more than a luminosity or chroma threshold value.

Thus average Y, U and V values are calculated and stored for each of, for example, four immediately preceding fields.

Within the history of the four fields, minimum and maximum average values are located thus determining a dynamic range of the values in the four fields.

A threshold parameter, AVG_Y_DELTA_THRES, is added to the maximum Y value and the same value of the parameter subtracted from the minimum Y to produce an AdjustedYMax and AdjustedYMin respectively.

For a current input field, immediately succeeding the four fields, a trigger or flag avgYtrigger is set to “1” if the Y average of the current input field>AdjustedYMax OR Y average<AdjustedYMin. Otherwise avgYtrigger retains a value “0”.

The same process is performed for the minimum and maximum average chroma values, using a parameter AVG_UV_DELTA_THRES, resulting in an AdjustedUMax, AdjustedUMin, AdjustedVMax and AdjustedVMin.

Similarly a U or V average trigger or flag results if the U or V average of the current input field>AdjustedUMax or AdjustedVMax respectively OR the U or V average<AdjustedUMin or AdjustedVMin respectively.

Useful values of the thresholds have been found to be:

AVG_Y_DELTA_THRES=2; and

AVG_UV_DELTA_THRES=1.

These threshold values may be variables that can be adjusted over a period of time in response to long term statistical knowledge of the image sequence; however in practice it is found that good results are obtained with the fixed values given, which avoids additional complexity of implementation.

Although determination of maximum and minimum values over four preceding fields has been described, it will be understood that the values may be obtained over any number of fields sufficient to provide representative values of a scene represented by the preceding fields.

### Activity Metrics

This metric is used to detect 61 an abrupt change in horizontal or vertical activity which, taken with other metrics, may signify a scene cut.

Activity is defined as energy output of a high pass filter applied to a field and can be calculated in a multitude of ways. Thus, horizontal activity is an energy output of a high pass filter of a field in a horizontal direction. Similarly vertical activity is an energy output of a high pass filter of a field in the vertical direction.

Any way of calculating activity is acceptable as long as the final result is normalized, for example to 16-bits. The horizontal and vertical activities used in this process make use of a range multiplier that is, for example, in the form of a Look-Up Table (LUT). A multiplier obtained from the LUT is used dynamically to adjust a margin between minimum and maximum values over the four history fields for low activity scenes. This is because during a still sequence comprising low activity, the activity range approaches zero. Thus when there is a sudden increase in activity due to movement for example, this could potentially trigger a scene cut. By dynamically adjusting the range by means of a multiplier when this situation arises, such a false trigger is prevented.

The LUT is as follows (where the prefix ‘0x’ indicates hexadecimal values):

| Activity Range | Multiplier |
|---|---|
| 0x7FFFFFFF | 0 |
| 0xF00 | 1 |
| 0xD80 | 2 |
| 0xC00 | 3 |
| 0xA80 | 4 |
| 0x900 | 5 |
| 0x780 | 6 |
| 0x600 | 7 |
| 0x480 | 8 |
| 0x300 | 9 |
| 0x180 | 10 |

In order to obtain a multiplier from the LUT, starting at Multiplier=0: if an activity range over the four field history is less than the corresponding ‘Activity Range’, then the next multiplier value is taken and the check performed again. When the check fails, the corresponding multiplier is the one that is used.

The analysis of the activity metrics is as follows:

range=maximum−minimum values within the four field history

Find a range multiplier that corresponds to the range using the RangeMultiplier LUT

min=Horizontal activity−Minimum value within the history

max=Horizontal activity−Maximum value within the history

If ((Horizontal activity<Minimum value in history) AND (min<−(range*multiplier))) OR If ((Horizontal activity>Maximum value in history) AND (max>range*multiplier)) then a horizontal activity trigger results 62.

Similarly a vertical activity trigger could result 62.

Although determination of maximum and minimum values over four preceding history fields has been described, it will be understood that the values may be obtained over any number of fields sufficient to provide representative values of a scene represented by the preceding fields.

### Temporal Difference

Temporal difference is a pixel by pixel difference between two different fields separated in time. A difference between the pixels of the two fields is accumulated and the difference presented 61 as a single value.

Operation of a temporal difference trigger is as follows:

currTempDiff=the temporal difference between the current input field and the previous field of the same parity;

if (currTempDiff>(previous currTempDiff*(1+FACTOR))) then a temporal trigger results 62.

It is found that a value of FACTOR=0.2 is suitable.

This FACTOR threshold value may be a variable that could be adjusted over a period of time in response to long term statistical knowledge of the image sequence; however in practice it is found that good results are obtained with the value given which avoids additional implementational complexity.

Simulations have revealed that the analysis of temporal difference is a very good way of determining whether a SC occurs. Because of this, its trigger is preferably weighted more heavily than the triggers of Average Luma or Chroma and Activity changes.

### Histograms

Histograms of consecutive pictures in a spatial domain are obtained and are then used to calculate 61 a normalized match index using the following equation:

$$S ( {H}_{i} , {H}_{j} ) = \frac{{\sum }_{k = 1}^{n} min ( {H}_{i} , {H}_{j} )}{{\sum }_{k = 1}^{n} {H}_{i}}$$

where, S(Hᵢ,Hⱼ) is a normalized match index, and n is a total number of bins in the histogram of each frame.

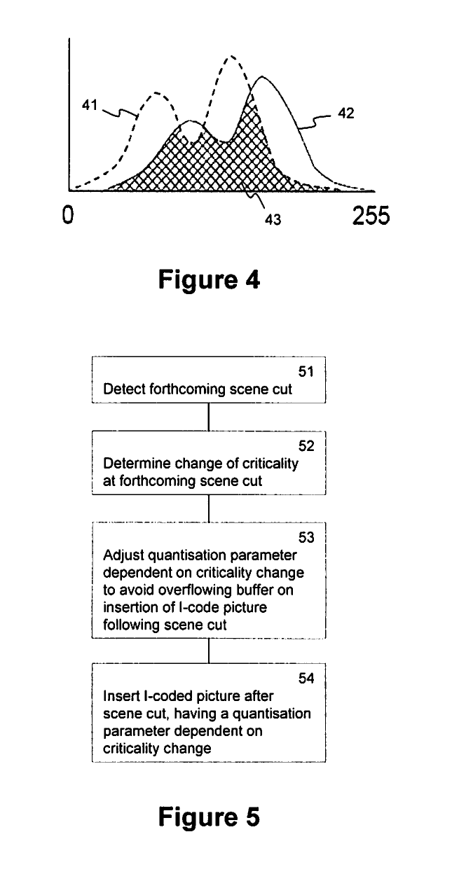

Referring to FIG. 4, the normalized match index (NMI) between two histograms 41, 42 is an area 43 common to both histograms. Thus comparing this with the area of the histograms of one of the pictures involved, a measure of the similarity between the consecutive pictures is obtained. Whenever there is a scene change, the normalized match index will have a very low value. The shaded region 43 in FIG. 4 is the common area. NMI always lies in the range of 0 to 1, where 0 denotes no intersection between the constituent histograms, the case of a definite scene change, and 1 denotes a perfect match or overlap of both the histograms and hence not of a scene change. If the NMI drops below 0.6 the histogram detector indicates 62 a scene cut.

### Combining Triggers

Each of the triggers described above will vary in its accuracy in detecting a scene change depending on the picture material and so any one taken alone will not be as reliable as a decision based on several different analyses based on different parameters and metrics. Combining 63 the individual triggers increases a probability of achieving a reliable overall trigger indicating detection 51 of a scene cut. Furthermore, weighting the contribution of each in response to the image statistics ensures that each contributes optimally to the final decision whether a scene change has been detected.

In the example metrics described above there are seven triggers and in order to decide if a SC is to be flagged the following tests are applied:

FinalTriggerVal=avgYtrigger+avgUtrigger+avgVtrigger+horzActTrigger+vertActTrigger+2*TemporalDiffTrigger+HistTrigger

If (FinalTriggerVal>=TRIGGER_THRES) then a SC is triggered overall 64.

Note that with the weighted seven metrics described above, a value of TRIGGER_THRES=5 has been found to be suitable. The higher this threshold, the more triggers are needed to flag a SC overall. This corresponds to the filtering nature of the process.

This threshold value may be a variable that could be adjusted over a period of time in response to long term statistical knowledge of the image sequence; however in practice it is found that good results are obtained with the value given which avoids additional implementational complexity.

It will be understood that means of combining possible triggers other than the weighted summation described herein may be used.

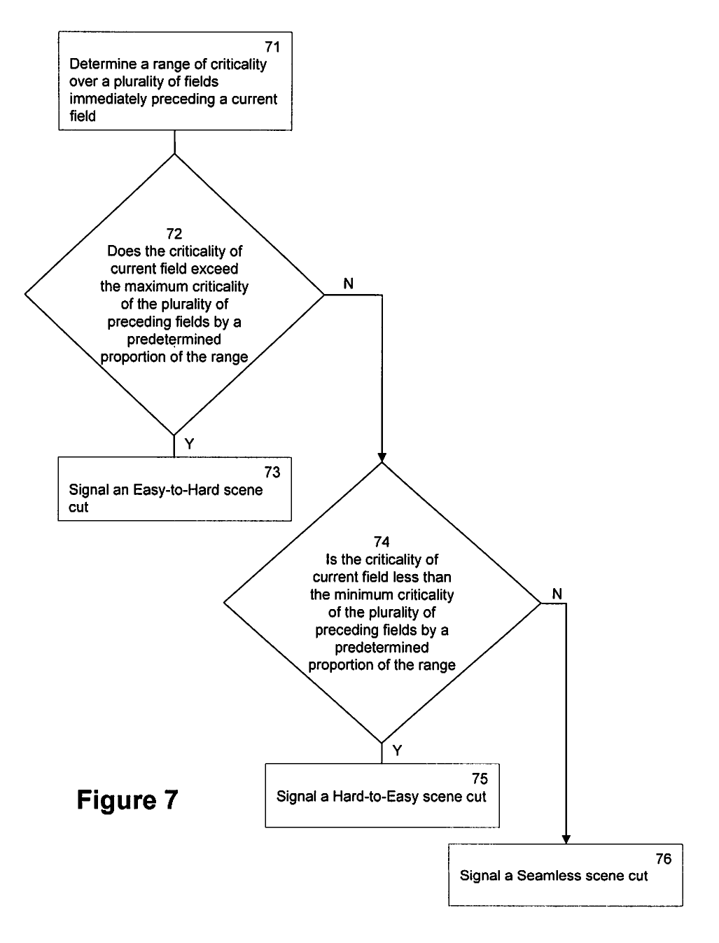

Referring to FIGS. 5 and 7, an embodiment of the invention provides 52 a forecast of what type of scene transition is to occur by monitoring the new scenes' criticality in relation to those within the four field history. Note that criticality is a summation of horizontal and vertical activities of a picture. Flagging of a type of scene transition is carried out as follows:

Determine 71 range=maximum criticality value−minimum criticality value within the four field history

Determine 72 whether (current criticality>(maximum criticality value+CRIT_THRES*range)) then an EASY to HARD scene transition has been detected 73.

Else if it is determined 74 that (current criticality<(minimum criticality value+CRIT_THRES*range)) then a HARD to EASY scene transition has been detected 75.

Else a SEAMLESS transition (little change in criticality between the two scenes) has been detected 76.

It has been found that a value of CRIT_THRES=1 is suitable.

This threshold value may be a variable that can be adjusted over a period of time in response to long term statistical knowledge of the image sequence; however in practice it is found that good results are obtained with the value given which avoids additional implementational complexity.

This invention provides means to avoid degradations caused by scene changes in the prior art, by judicious analysis of video material before it enters a compression coder and by producing from this analysis reliable indicators to signal 64 the compression coder of an impending scene change. This invention also provides an improved scene cut detection process that makes decisions based on multiple triggers and exploits statistical histories of selected features of the image sequence. Furthermore embodiments of the invention employ dynamically adjusted thresholds for each indicator with majority voting on the several trigger results to reach a decision on whether a scene cut exists or not. Unlike some prior art systems for scene detection, the system of the invention operates separately from, and ahead of, the encoding process thus enabling the encoder to ready itself for the flagged scene cut, for example, by adjustment 53 of a quantisation parameter prior to the detected scene cut.

1.-26. (canceled)

27. A method of detecting in a video stream a scene cut between a current field of the video stream and an immediately preceding field and encoding the video stream, the method comprising the steps of:
a. determining differences for a first plurality of image parameters between values of the image parameters for a current field and for one or more immediately preceding fields;
b. setting a flag value for each parameter indicating whether a possible scene break exists between the current field and the immediately preceding field dependent on the respective differences;
c. combining the flag values for each parameter to form a combined parameter;
d. generating a scene break trigger signal indicating a scene break between the current field and the immediately preceding field if the combined parameter exceeds a predetermined trigger threshold;
e. determining a change of criticality at the forthcoming scene cut;
f. adjusting a quantisation parameter dependent on the criticality change to avoid overflowing a buffer on encoding of a field following the scene cut as an intra-coded field; and
g. encoding a field following the scene cut as an intra-coded field having a quantisation parameter dependent on the criticality change; such that encoding of forward or backward coded fields prior to or following the scene change is based only on fields preceding or following the scene change, respectively.

28. A method as claimed as in claim 27, wherein the image parameters include at least one of average luminosity, average chroma component, horizontal picture activity, vertical picture activity, temporal difference, histogram of a picture in a spatial domain and average motion vector magnitude.

29. A method as claimed in claim 28, wherein determining a difference comprises:
a. determining minimum and maximum values of at least one of luminosity and chroma values over a second plurality of immediately preceding fields; and
b. determining whether the values of the respective at least one of luminosity and chroma values for the current field is greater than the maximum value or less than the minimum value by a respective luminosity or chroma parameter threshold.

30. A method as claimed in claim 28, wherein determining a difference comprises:
a. determining a range between maximum and minimum values of at least one of vertical and horizontal activity over a second plurality of fields immediately preceding the current field;
b. selecting a range multiplier parameter dependent on the range;
c. determining a minimum parameter equal to a difference between the activity of the current field and the minimum activity in the second plurality of fields;
d. determining a maximum parameter equal to a difference between the activity of the current field and the maximum activity in the second plurality of fields; and
e. determining whether the activity is less than the minimum activity in the second plurality of fields and the minimum parameter is less than the range multiplier or if the activity is greater than the maximum activity in the second plurality of fields and the maximum parameter is greater than the range multiplier.

31. A method as claimed in claim 28, wherein determining a difference comprises:
a. determining a temporal difference between the current field and an immediately preceding field of a same parity; and
b. determining whether the temporal difference exceeds a previous temporal difference for an immediately preceding pair of fields by more than a predetermined factor parameter.

32. A method as claimed in claim 28, wherein determining a difference comprises:
a. determining a normalised match index between the current field and an immediately preceding field; and
b. determining whether the normalised match index is less than a predetermined histogram threshold.

33. A method as claimed in claim 27, wherein the step of setting a flag value comprises determining whether the difference exceeds a predetermined parameter threshold.

34. A method as claimed in claim 33, wherein the predetermined parameter threshold is variable in response to statistical knowledge of the image sequence of the video stream.

35. A method as claimed in claim 27, wherein combining the flag values comprises summing the flag values.

36. A method as claimed in claim 27 wherein combining the flag values comprises determining a weighted sum of the flag values.

37. A method as claimed in claim 27, wherein the trigger threshold is variable in response to statistical knowledge of the image sequence of the video stream.

38. A method as claimed in claim 27, wherein determining a change of criticality at a scene cut comprises the steps of:
a. determining a range of criticality over a plurality of fields immediately preceding the scene cut;
b. signalling an Easy-to-Hard scene cut if the criticality of the current field immediately following the scene cut exceeds a maximum criticality of the preceding plurality of fields;
c. signalling a Hard-to-Easy scene cut if the criticality of the current field immediately following the scene cut is less than a minimum criticality of the preceding plurality of fields; and
d. otherwise signalling a seamless scene cut.

39. An apparatus arranged to detect in a video stream a scene cut between a current field of the video stream and an immediately preceding field and encoding the video stream, the apparatus comprising:
a. a comparison module for determining differences for a first plurality of image parameters between values of the image parameters for a current field and for one or more immediately preceding fields;
b. a flag setting module for setting a flag value for each parameter indicating whether a possible scene break exists between the current field and the immediately preceding field dependent on the respective differences;
c. a flag combining module for combining the flag values for each parameter to form a combined parameter;
d. a trigger generating module for generating a scene break trigger signal indicating a scene break between the current field and the immediately preceding field if the combined parameter exceeds a predetermined trigger threshold;
e. a criticality change module arranged to determine a change of criticality at the forthcoming scene cut;
f. a quantisation parameter adjustment module arranged to adjust a quantisation parameter dependent on the criticality change to avoid overflowing a buffer on encoding of a field following the scene cut as an intra-coded field; and
g. an encoder arranged to encode a field following the scene cut as an intra-coded field having a quantisation parameter dependent on the criticality change; such that encoding of forward or backward coded fields prior to or following the scene change is based only on fields preceding or following the scene change, respectively.

40. An apparatus as claimed as in claim 39, wherein the image parameters include at least one of average luminosity, average chroma component, horizontal picture activity, vertical picture activity, temporal difference, histogram of a picture in a spatial domain and average motion vector magnitude.

41. An apparatus as claimed in claim 40, wherein the comparison module comprises:
a. a first module for determining minimum and maximum values of at least one of luminosity and chroma values over a second plurality of immediately preceding fields; and
b. a second module for determining whether the values of the respective at least one of luminosity and chroma values for the current field is greater than the maximum value or less than the minimum value by a respective luminosity or chroma parameter threshold.

42. An apparatus as claimed in claim 40, wherein the comparison module is arranged to:
a. determine a range between maximum and minimum values of at least one of vertical and horizontal activity over a second plurality of fields immediately preceding the current field;
b. select a range multiplier parameter dependent on the range;
c. determine a minimum parameter equal to a difference between the activity of the current field and the minimum activity in the second plurality of fields;
d. determine a maximum parameter equal to a difference between the activity of the current field and the maximum activity in the second plurality of fields; and
e. determine whether the activity is less than the minimum activity in the second plurality of fields and the minimum parameter is less than the range multiplier or if the activity is greater than the maximum activity in the second plurality of fields and the maximum parameter is greater than the range multiplier.

43. An apparatus as claimed in claim 40, wherein the comparison module is arranged to:
a. determine a temporal difference between the current field and an immediately preceding field of a same parity; and
b. determine whether the temporal difference exceeds a previous temporal difference for an immediately preceding pair of fields by more than a predetermined factor parameter.

44. An apparatus as claimed in claim 40, wherein the comparison module is arranged to:
a. determine a normalised match index between the current field and an immediately preceding field; and
b. determine whether the normalised match index is less than a predetermined histogram threshold.

45. An apparatus system as claimed in claim 39, wherein the criticality change module comprises:
a. a module arranged to determine a range of criticality over a plurality of fields immediately preceding the scene cut; and
b. signalling means arranged to signal to an Easy-to-Hard scene cut if the criticality of the current field immediately following the scene cut exceeds a maximum criticality of the preceding plurality of fields, to signal a Hard-to-Easy scene cut if the criticality of the current field immediately following the scene cut is less than a minimum criticality of the preceding plurality of fields; and otherwise to signal a seamless scene cut.

46. A computer program product comprising program code means arranged to perform all the steps of the method of detecting in a video stream a scene cut between a current field of the video stream and an immediately preceding field and encoding the video stream, the method comprising the steps of:
a. determining differences for a first plurality of image parameters between values of the image parameters for a current field and for one or more immediately preceding fields;
b. setting a flag value for each parameter indicating whether a possible scene break exists between the current field and the immediately preceding field dependent on the respective differences;
c. combining the flag values for each parameter to form a combined parameter;
d. generating a scene break trigger signal indicating a scene break between the current field and the immediately preceding field if the combined parameter exceeds a predetermined trigger threshold;
e. determining a change of criticality at the forthcoming scene cut;
f. adjusting a quantisation parameter dependent on the criticality change to avoid overflowing a buffer on encoding of a field following the scene cut as an intra-coded field; and
encoding a field following the scene cut as an intra-coded field having a quantisation parameter dependent on the criticality change; such that encoding of forward or backward coded fields prior to or following the scene change is based only on fields preceding or following the scene change, respectively.
